(19) United States
(12) Patent Application Publication
(10) Pub. No.: US 2006/0261278 A1
(43) Pub. Date: Nov. 23, 2006

(54) Soft x-ray imager with ten micrometer resolution

(76) Inventor: Roberto Accorsi, St. Davids, PA (US)

Correspondence Address: RATNERPRESTIA, P O BOX 980, VALLEY FORGE, PA, 19482-0980, US

(21) Appl. No.: 10/554,895

(22) PCT Filed: Apr. 28, 2004
(86) PCT No.: PCT/US04/13249

§ 371 Date: Oct. 28, 2005

Related U.S. Application Data
(60) Provisional application No. 60/466,657, filed on Apr. 30, 2003.

(51) Int. Cl. G01T 1/164

(52) U.S. Cl. 250/363.06

(57) ABSTRACT

The method of imaging a spatial distribution of photon emitters, the method includes producing an image with a resolution of at most about 180 microns using an imaging device including a detector and a coded aperture, wherein a photon emitted from the photon emitter has an energy of at most about 35 keV (5.6×10⁻¹⁵ J). Further provided is an imaging device for imaging a distribution of photons having energies of at most about 35 keV (5.6×10⁻¹⁵ J), which includes a coded aperture comprising a mask pattern having a plurality of holes, wherein the coded aperture is adapted to provide a resolution of at most about 180 micron, a detector on which a raw image is projected through the coded aperture; and a decoder that receives the raw image from the detector and produces an image having a resolution of at most about 180 micron.

### CROSS-REFERENCE TO RELATED APPLICATIONS

This application claims a benefit of U.S. Provisional Application No. 60/466,657 filed on Apr, 30, 2003, titled 10-MUM RESOLUTION IMAGER FOR SOFT X-RAY EMITTERS, which is incorporated herein in its entirety.

### STATEMENT REGARDING FEDERALLY SPONSORED RESEARCH OR DEVELOPMENT

This research was supported in part by U.S. Government funds (Grant No. 1 R21 EB002610-01 from the National Institute of Biomedical Imaging and Bioengineering of the NfH), and the U.S. Government may therefore have certain rights in the invention.

### BACKGROUND OF THE INVENTION

1. Field of the Invention

This invention relates to imaging of radiation-emitting objects and, more particularly, it relates to imaging of radioactive sources with a resolution of about 10 micron, i.e. on the same scale as individual human somatic cells.

2. Description of Related Art

Radionuclide imaging is an established technique capable of providing functional information at the molecular level with both high specificity and high sensitivity. The technique is based on labeling molecules with a radioactive atom before their release in the system under study. The spatial distribution of the molecules can then be followed in time by imaging the location of the emitted radiation. A large number of isotopes can be imaged. The broadest classification is their separation in gamma and positron emitters, the former is at the basis of single photon emission methods (such as scintigraphy and tomography or SPET) and the latter is used in Positron Emission Tomography (PET).

Recent interest in small animal imaging increased the emphasis on the question of the ultimate resolution limit of these instruments. Further improvement of state-of-the-art PET systems (see, for example, Tai et al., “MicroPET II: An Ultra-high Resolution Small Animal PET System,” IEEE 2002 Medical Imaging Conference Proceedings) some of which are capable of 1 mm resolution (see Jeavons et al., “A 3d HIDAC-PET with sub-millimetre resolution for imaging small animals,” IEEE Transactions on Nuclear Science, 46,468-473, 1999) will have to face increasing instrumentation costs and eventually fundamental physical limits such as finite positron range and photon non-colinearity. Single-photon imagers with sub-millimeter resolution have already been designed and built both with dedicated detectors and as adaptations of pre-existing clinical-type equipment (see MacDonald et al., “Pinhole SPECT of Mice Using the LumaGEM Gamma Camera,” IEEE Transactions on Nuclear Science, 48,3, 830-836,2001; and Acton et al., “Ultra-high resolution single photon emission tomography imaging of the mouse striatum,” European Journal of Nuclear Medicine, 29, 3, 446, 2002). These systems are based on the combination of a position-sensitive detector with some absorptive collimation optics to associate each detected event with an emission location (see J. A. Sorensen and M. E. Phelps, Physics in Nuclear Medicine, Grune and Stratton, Orlando, 1987). Their performance limit is set by a trade-off among many parameters, the most notable of which are usually resolution, sensitivity and Field of View (FoV). Coded aperture imaging has been proposed in the past as a means for improving the spatial resolution, sensitivity, and signal-to-noise ratio (SNR) of images formed by x-ray or gamma ray radiation (see Caroli et al., “Coded aperture imaging in x- and gamma-ray astronomy,” Space Science Reviews, 45,349-403,1987;and G. K. Skinner, “Imaging with coded aperture masks,” Nuclear Instruments and Methods in Physics Research, 221, 33-40, 1984). For many imaging applications, coded aperture cameras have proven advantageous relative to other candidate systems, including the single pinhole camera and collimator systems. In coded aperture imaging, radiation from the object to be imaged is projected through the coded aperture mask and onto a position-sensitive detector. The coded aperture mask is an arrangement of many pinholes in particular patterns. The raw signal from the detector does not reflect a directly recognizable image, but instead represents the signal from the object that has been modulated or encoded by the aperture pattern. The recorded signal can then be digitally or optically processed to extract a reconstructed image of the object (see Accorsi et al., “Optimal coded aperture patterns for improved SNR in nuclear medicine imaging,” Nuclear Instruments and Methods in Physics Research, 474(3): 273-284, 2001 and references therein).

The following equations regulate interdependences between resolution, sensitivity and Field of View (FoV) for a pinhole:

$$\begin{matrix}{λ}_{s} = \sqrt{{λ}_{g}^{2} + {λ}_{i}^{2}} = \sqrt{{{w}^{2} ( 1 + \frac{1}{m} )}^{2} + {( \frac{{FWHM}_{i}}{m} )}^{2}} & ( 1 ) \\ g = {( \frac{w}{4 a} )}^{2} & ( 2 ) \\ FoV = \frac{a}{b} D = \frac{D}{m} & ( 3 )\end{matrix}$$

where λₛ is system resolution, w is the diameter of the pinhole, D the side ofthe detector's active area, FWHMᵢ its intrinsic resolution, a the object-to-pinhole distance, b the pinhole-to-detector distance and m magnification, defined as the ratio of the size of the projection of the object on the detector and the size of the object itself (see J. A. Sorensen and M. E. Phelps, supra; H. Anger, Radiosotope cameras, in G. J. Heine (ed.) Instrumentation in Nuclear Medicine, vol. 1, pp. 516-17, Academic Press, New York, 1967; and H. H. Barrett and W. Swindell, Radiological Imaging, Academic Press, New York, 1981. The equation (1) is based on the common assumption that system resolution (λₛ) is given by the sum in quadrature of geometric (λ_{g}) and intrinsic (λᵢ) resolution.

For an ideal (infinitely small) pinhole, w=0, and the equation (1) shows that resolution is limited by the intrinsic resolution of the detector. For a perfect detector (FWHMᵢ=0), the equation (1) shows that resolution is proportional to w. On the other hand, the equation (2) shows that the sensitivity g is proportional to w², so that better (i.e. lower) resolution leads to worse sensitivity, unless a is reduced. However, the equation (3) shows that for given D and b, a reduction in a implies a reduction in FoV. Furthermore, as discussed below, practical constraints may pose a limit on the minimum a.

The equation (1) also shows that resolution better than the intrinsic resolution of the detector can be obtained if a magnifying geometry (m>1, i.e. b>a) is used (see D. A. Weber and M. Ivanovic, “Pinhole SPECT: Ultra-high-resolution imaging for small animal studies,” Journal of Nuclear Medicine, 36, 12, 2287-2289, 1995). To achieve good resolution, parallel-hole collimators, for which m=1 and whose resolution and sensitivity can be calculated with similar equations (see J. A. Sorensen and M. E. Phelps, supra), must be coupled with research-type detectors having outstanding intrinsic resolution. For example, Kastis et al. have coupled a tungsten collimator with a 380 μm-pitch CZT detector (see Gamma-ray imaging using a CdZnTe pixel array and a high-resolution, parallel-hole collimator, IEEE Transactions on Nuclear Science, 47, 6, 1923-1927, 2000). Magnification is achieved more readily with pinholes than with converging collimators. A representative pinhole system designed for ^{99m}Tc photons (140 keV) uses a 1-mm diameter pinhole, a=3.3 cm and b=26 cm (m=7.9) with D=30 cm (see Habaken et al.,“Evaluation of High-Resolution Pinhole SPECT Using a Small Rotating Animal,” Journal of Nuclear Medicine, 42, 1863-1869, 2001). With these numbers, the equations above show a geometric resolution of 1.1 mm (1.2 mm system resolution assuming 3.7 mm FWHMᵢ, the intrinsic resolution specified for a Siemens E-Cam) and a sensitivity of 5.7×10⁻⁵ (57 cps/MBq) over a FoV of 3.8 cm, which compare to an experimental system resolution of 1.3 mm and sensitivity of 48.5 cps/MBq.

To further improve resolution two problems must be faced: pinhole penetration and sensitivity. In fact, if pinholes were cut in an ideal material perfectly opaque to gamma rays, the material could be infinitely thin and the FoV would only be limited by the size of the detector. However, in practice, materials have a finite absorption coefficient μ and some finite thickness must be used. To maintain a large FoV, pinholes seldom have a straight axial profile, but rather have a ‘knife-edge’ to pass photons with a larger acceptance angle t Penetration at the edge is more pronounced, and resolution is reduced because the pinhole appears to photons to be larger than its actual size. The effect has been quantified by defining the effective diameter wₑ in the equation (4):

$${w}_{e} \sqrt{w ( w + \frac{2}{μ} tan ( α / 2 ) ) + \frac{2}{μ} tan ( α / 2 )} \qquad ( 4 )$$

Even if this definition was originally based on sensitivity considerations, the effective diameter is commonly used in place of the physical diameter w in the equation (1) to calculate resolution (see M. F. Smith and R. J. Jaszczak, The effect of gamma ray penetration on angle-dependent sensitivity for pinhole collimation in nuclear medicine, Medical Physics, 24, 11, 1701-1708, 1997; and Jaszczak et al., Pinhole collimation camera for ultra-high resolution, small field of view SPECT, Physics in Medicine and Biology, 39, 425-437, 1994).

The equation (4) shows that, when penetration is accounted for, even a physically closed pinhole (w=0) leads to finite geometric resolution. For example, for 140 keV and an α=100° pinhole made of gold, wₑ=0.56 mm. This result depends only on the attenuation coefficient (and hence on the energy of the photons) and the acceptance angle.

Two approaches have historically been proposed to overcome the well-known limit of sensitivity in pinhole imaging while maintaining fundamental design parameters such as detector dimensions, FoV and resolution. Both rely on increasing the number of pinholes used, to which sensitivity is in first approximation proportional. A multiple pinhole system is one in which the different pinholes cast projections of the object on distinct parts of the detector. A coded aperture system is one in which the projections could overlap. A disadvantage of multiple pinholes is that their number and magnification are limited to keep projections separated. A disadvantage of coded apertures is that the increased sensitivity does not always translate in increased Signal-to-Noise Ratio (SNR). The basics of coded aperture imaging will now be described with the goal of analyzing in more detail the conditions under which it provides better SNR than a pinhole.

Coded aperture imaging was originally developed to improve the SNR of X-ray astronomy instrumentation (Caroli et al., supra; and G. K. Skinner, supra) and was successively applied to other fields, such as physics (Fenimore et al., “Uniformly redundant array imaging of laser driven compressions: preliminary results,” Applied Optics, 18, 945-947, 1979; and Chen et al., “Three-dimensional reconstruction of laser-irradiated targets using URA coded aperture cameras,” Optics Communications, 71, 249-255, 1989) and medicine (J. S. Fleming and B. A. Goddard, “An evaluation of techniques for stationary coded aperture three-dimensional imaging in nuclear medicine,” Nuclear Instruments and Methods in Physics Research, 221, 242-246, 1984; Liu et al., “A novel geometry for SPECT imaging associated with-the EM-type blind deconvolution method,” IEEE Transactions on Nuclear Science, NS-45, 2095-2101, 1998; H. H. Barrett, “Fresnel zone plate imaging in nuclear medicine,” Journal of Nuclear Medicine, 13, 382-385, 1972; Koral et al., “Thyroid scintigraphy with time-coded aperture,” Journal of Nuclear Medicine, 20,345-349,1979; and Rogers et al., “Coded-Aperture imaging ofthe heart,” Journal of Nuclear Medicine, 21, 371-378, 1980). The fundamental idea is to increase signal throughput by opening multiple pinholes, which are kept small to preserve resolution. Since the distance to the object is not affected, sensitivity is increased preserving the FoV. Each pinhole generates an image of the object on the detector (see FIG. 1) and all projections overlap, so the detector does not produce an image directly. However, from the overlapped copies and knowledge of the locations of all pinholes, a clear image of the object can be recovered. The restoration process is fast and does not introduce artifacts if certain arrangements ofthe pinholes (so-called coded apertures or masks) are used. An alternative way of looking at the same process is to think that each point source in the object casts a shadow of the aperture on the detector. Each point source, thus, does not appear as a single bright spot, but rather as a recognizable pattern of spots. In this sense, the aperture is encoding the signal from the source. Due to encoding, the data are not immediately interpretable. To show how an image is decoded, it is convenient to start from a mathematical description of the physical process of projection through the aperture. FIG. 1 is a scheme depicting a concept of coded aperture camera adapted from E. E. Fenimore and T. M. Cannon, supra, wherein a subject 1 emits a radiation which is passing through a coded aperture 2 and a detector 3 for a recorded (raw) image, which is then decoded by a computer or a decoder 4 to create an image 5.

From elementary geometry, the data recorded by the detector (R) can be shown to be related to the correlation (x) of the source distribution (or object O) with the aperture pattern (A) (see FIG. 1):
R=O A (5)

The aperture pattern A is a generic transmission function ranging from 0 to 1, to indicate, respectively, total opaqueness or transmission to impinging gamma rays. Very often it assumes the simplified form of a square binary array, i.e. whose positions take on two values only, 0's and 1's (see FIG. 2A). Many choices of A are available in the literature (see Caroli et al., supra; and R. Accorsi, “Design of Near-Field Coded Aperture Cameras for High-Resolution Medical and Industrial Gamma-Ray Imaging,” Ph.D. thesis, Massachusetts Institute of Technology, Cambridge, Mass., 2001 The relevant property of these patterns is the existence of an associated decoding pattern G, which is often also binary, such that the periodic correlation A ⊕ G is a δ function. The condition that A and G be binary is not strictly necessary for successful imaging, but is convenient for fabrication and results in best noise properties (see Busboom et al., “Coded aperture imaging with multiple measurements,” Journal of the Optical Society of America, A 14, 5, 1058-1065, 1997). If G exists, a perfect image of O can be reconstructed by taking the periodic correlation of R with G. This relationship can be represented as follows:
R ⊕ G=(O×A)⊕ G=O*(A⊕G)=O*δ=O (6)
where * indicates convolution. This second step is called decoding. Depending on the size of the matrix of acquired data, decoding ofthe pattern in FIG. 3A takes a few tenths of a second on a computer. Under certain conditions, the increased sensitivity enhances the SNR of the reconstructed images (E. E. Fenimore, “Coded aperture imaging: predicted performance of uniformly redundant arrays,” Applied Optics, 17, 22, 3562-3570, 1978; and Accorsi, et al., “Optimal coded aperture patterns for improved SNR in nuclear medicine imaging,” Nuclear Instruments and Methods in Physics Research A, 474, 3, 273-284, 2001).

The importance of the Signal-to-Noise Ratio (SNR) in coded aperture imaging is explained below. The overlap of the different copies of the object in the acquired data makes the relationship between sensitivity and SNR more involved than in systems with no superposition, where the SNR is essentially the square root of the sensitivity. The origin ofthe SNR advantage of coded aperture imaging is best explained in the simple case of a point source. Consider a pinhole camera passing Sᵢⱼ photons. According to Poisson statistics, the variance of this signal is also Sᵢⱼ, so that the standard deviation of the noise is \sqrt{Sᵢⱼ}, and the SNR is also \sqrt{Sᵢⱼ}. If a coded aperture made of N pinholes ofthe same size as that ofthe pinhole camera (so that resolution is constant) is used instead, the photons passed are NSᵢⱼ. They are collected at N different places on the detector. These are N independent measurements of the same random variable, so the variance is the sum of the variances, or NSᵢⱼ, and the SNR is \sqrt{NSᵢⱼ}. Since, depending on applications, N can be 50000 or more, a coded aperture can produce images with the same SNR and resolution of a pinhole camera in a time 50000 times shorter. This enormous advantage ultimately comes from using parts of the detector that, for a point source, would not be used with a single pinhole. Since a larger object would take a larger portion ofthe detector, it is not possible to obtain the same number of separate copies. If copies overlap, statistical independence is not warranted and the SNR argument above does not hold. So, if the object is more complex, the SNR advantage is lower than the theoretical maximum achieved with point sources. A mathematical derivation is needed to quantify the loss (R. Accorsi, “Design of Near-Field Coded Aperture Cameras for High-Resolution Medical and Industrial Gamma-Ray Imaging,” Ph.D. thesis, Massachusetts Institute of Technology, Cambridge, Mass., 2001; Busboom et al., “Coded aperture imaging with multiple measurements,” Journal ofthe Optical Society of America, A14, 5, 1058-1065, 1997; E. E. Fenimore, supra; and Accorsi, et al., “Optimal coded aperture patterns for improved SNR in nuclear medicine imaging,” Nuclear Instruments and Methods in Physics Research A, 474, 3, 273-284, 2001; S. R. Gottesman and S. R. Schneid, “PNP—A new class of coded aperture arrays,” IEEE Transactions on Nuclear Science, NS-33, 745-749, 1986). The key concept in these derivations is the concentration parameter. To define it, the FoV is divided in a square grid of as many squares as those forming the coded aperture. These are the reconstruction positions. Sᵢⱼ is the number of counts due to activity present at the reconstruction position (ij) and passing through a single aperture hole. The concentration parameter ψᵢⱼ is defined as:

$${ψ}_{ij} ≡ \frac{{S}_{ij}}{{\sum }_{i , j} {S}_{ij}} \qquad ( 7 )$$

From its definition, ψᵢⱼ is the fraction of the total activity present at each reconstruction position. It may be different at all points of the image, ranging from 0, for points with no activity, to 1. For example, for a point source, ψᵢⱼ=1 at the source and ψᵢⱼ=0 elsewhere. Notably, that this is the only case in which ψᵢⱼ can be 1. If N_{T} is the total number of reconstruction positions, for a uniform source ψᵢⱼ=1/N_{T} everywhere.

The SNR depends on several other parameters (Accorsi, et al.supra) the most important is ψᵢⱼ. The SNR of the most common pattern family (Uniformly Redundant Arrays, URA) is given by the following equation:
SNRᵢⱼ^{CA}=\sqrt{NI_{T}}ψᵢⱼ (8)
where I_{T}=ΣᵢⱼSᵢⱼ and N is the number of holes (i.e. the number of open positions) in the aperture (see E. E. Fenimore and T. M. Cannon, “Coded aperture imaging with uniformly redundant arrays,” Applied Optics, 17, 337-347, 1978). The SNR is proportional to ψᵢⱼ. The theoretical maximum \sqrt{NI_{T}} is reached for ψᵢⱼ=1, i.e., as anticipated, only in the case of a single point source. In all other cases, ψᵢⱼ<1. It is instructive to cast the expression above in the form:
SNRᵢⱼ^{CA}=\sqrt{I_{T} ψᵢⱼ} \sqrt{N} \sqrt{ψᵢⱼ}=\sqrt{Sᵢⱼ} \sqrt{N} \sqrt{ψᵢⱼ} (9)
and to compare it to the expression of the SNR of a pinhole, which is, as discussed above:
SNRᵢⱼ^{Pinhole}=\sqrt{Sᵢⱼ} (10)

By definition, Sᵢⱼ, the number of photons passing through a pinhole, is proportional to sensitivity. From the equation (10), it follows that, for a pinhole, sensitivity and SNR are equivalent, so higher sensitivity implies higher SNR. For a coded aperture one must first consider whether the increased sensitivity NSᵢⱼ, outweighs superposition losses. In fact, from these two equations, the SNR of a coded aperture equals the SNR of a pinhole multiplied by two factors. The first, always greater than 1, is the number of pinholes in the aperture. The second is the concentration parameter: since it is always less than or equal 1, it represents the SNR loss due to superposition. There is an SNR advantage only at those points for which ψᵢⱼ>I/N. If the object is spread over relatively few reconstruction positions, ψᵢⱼ can be greater than 1/N at all points of the image. At the other extreme, for a uniform activity distribution over the whole FoV, ψᵢⱼ=1/N_{T}, which is always less than 1/N. Therefore, a pinhole can have better SNR at all points of the image. In the great majority of cases bright parts of the image will be better imaged with a coded aperture and dim parts with a pinhole. For example, a calculation for the thyroid study on which many past studies have focused (e.g. J. S. Fleming and B. A. Goddard, supra) shows that coded apertures have only a slight SNR advantage over the pinhole. Cases more favorable to coded apertures, however, are quite common. In fact, if the activity is limited to a fraction f of the FoV, then ψ_{if}=1/fN_{T}. From the equations above, it follows that a uniform source confined to a 2×2 cm² area however distributed on a 9×9 cm² FoV is imaged with a SNR advantage of about 3.2, which is a factor of 10 in activity or time. If only a narrow line of activity crossing the whole FoV is present (e.g. a capillary tube or a blood vessel), ψ_{if}=1/\sqrt{Nₜ} and the SNR increases by a factor ⁴\sqrt{N/2}.

There have been attempts to improve the system resolution of nuclear imagers by varying a design of a coded aperture such as the size and the number of holes (see R. Accorsi, Design of Near-Field Coded Aperture Cameras for High-Resolution Medical and Industrial Gamma-Ray Imaging, Thesis in Nuclear Engineering, Massachusetts Institute of Technology, May 2001).

U.S. Pat. No. 5,606,165 to Chiou et al. describes a coded aperture imaging system for mapping a radiation exposure in an area.

U.S. Pat. No. 6,205,195 to Lanza describes apparatus and methods for imaging and detection of the elemental composition of an object, wherein gamma-rays having the intensity of at least 1 MeV and emanating from the object are measured by utilizing coded aperture detection systems.

The system resolution of nuclear imagers is usually limited by two factors: the intrinsic resolution of the detector and penetration of the optics. Conventional optical elements of these dimensions cannot obtain sufficient sensitivity. For example, a 10-μm pinhole passes 2.5×10⁻⁷ of incident photons at a distance of 5 mm. Accordingly, formation of a clear image requires long acquisition times or use of a level of activity much higher than obtainable in the small volume imaged.

Beekman et al. have recently shown that the use of ¹²⁵I(27-35 keV) in place of ^{99m}Tc (140 keV) photons makes it possible to use 100-μm diameter micro-pinholes and achieve resolution of 184 micron with an Anger camera (see Towards in vivo nuclear microscopy: iodine-125 imaging in mice using micro-pinholes, European Journal of Nuclear Medicine, 29, 7, 933-938, 2002). Sensitivity was about 2.5×10⁻⁵ (25 cps/MBq), which is similar to that of 1-mm resolution imagers. This was possible in spite of the dramatic improvement in resolution because the distance to the object was reduced from 33 to 5 mm. The main disadvantage is the reduction in FoV, which is proportional to the reduction in distance from the object. Further, while helpful in the design of the optics, reduced penetration potentially poses a problem of attenuation in the object. It is impractical to further scale down the pinhole when using Anger-camera design. For example, for 10 keV photons and a pinhole aperture angle α=100°, an Au pinhole has an effective diameter of 7.5 μm. At 5 mm from the object, sensitivity would be less than 1.4×10⁻⁷ (0.14 cps/MBq). To recover the two orders of magnitude lost in sensitivity, the distance to the object must be reduced by a factor of 10, however the FoV would be reduced to 0.5 mm and the distance to the object would be only 0.5 mm, which may be impractical for many applications. Finally, the intrinsic resolution of conventional Anger cameras worsens with decreasing photon energy. Even assuming an intrinsic resolution in the order of 3 mm, a high magnification of about 300 would be necessary to achieve 10-micron resolution, also setting a limit on the FoV. Attenuation of low-energy photons in any material used to isolate the crystal should also be considered. When low energy isotopes are used to seek high resolution, the performance limit is set by a combination of sensitivity, FoV and distance from the object rather than by penetration. A pinhole cannot provide adequate sensitivity because it cannot be moved closer to the object than in current designs while maintaining a practical FoV and distance from the object. Moreover, a custom-made gamma detector, where crystal thickness would be optimized to avoid degradation of intrinsic resolution is necessary for best performance and may not be justified by efficiency gains. Thus, even though Beekman et al. have achieved a higher system resolution by using a smaller size pinhole and lower energy photons (27-35 keV in place of ^{99m}Tc 140 keV), it is impractical to further scale down the pinhole when using Anger-camera design.

Despite the foregoing developments, there is a need in the art for a device and a method of imaging objects on a cellular scale.

All references cited herein are incorporated herein by reference in their entireties.

### BRIEF SUMMARY OF THE INVENTION

The use of tracers emitting low-energy photons reduces penetration and typically increases detection efficiency, making high-resolution detectors available. The present invention utilizes 3-10 keV photons to design imaging optics on a scale of a few microns.

The invention describes the design and performance of a high-resolution soft X-ray imager comprising a CCD camera and coded aperture optics to improve sensitivity by several orders of magnitude over conventional optics. Under conditions predictable from theory, the sensitivity improvement translates in full or part to image Signal-to-Noise Ratio (SNR) correct. The system is designed for 280 micron resolution or less and SNR sufficient to produce an image in practical acquisition times (<5 min).

Accordingly, the invention provides a method of imaging a spatial distribution of photon emitters, the method comprising producing an image with a resolution of at most about 180 micrometers using an imaging device comprising a detector and a coded aperture, wherein a photon emitted from the photon emitter has an energy of at most about 35 keV (5.6×10⁻¹⁵ J). In certain embodiments, the energy of the photon is about 1 keV (1.6×10⁻¹⁶ J) to about 10 keV (1.6×10⁻¹⁵ J). In certain embodiments, the photon emitter has energy of at least 3 keV (4.8×10⁻¹⁶ J).

In certain embodiments, the photon emitter is a radioactive isotope of an element. In certain embodiments, the element is at least one of Periodic Table Elements 18 through 80. Preferably, the element is at least one of Periodic Table Elements 18 through 32 and 47 through 80. More preferably, the element is a member selected from the group consisting of Fe, K, Ca, Cr, Mn, Cu, Zn, Co, and I.

In certain embodiments, the resolution of at least about 10 micron is measured over a field of view of at least about 8.2 mm.

In certain embodiments, the imaging device comprises a rotation assembly adapted to rotate the coded aperture by about a 90 degree angle such that at least a portion of near-field artifacts is eliminated from the image.

In certain embodiments, a biological specimen is observed, either statically or dynamically.

Further provided is an imaging device for imaging a distribution of photons having energies of at most about 35 keV (5.6×10⁻¹⁵ J), the imaging device comprising a coded aperture comprising a mask pattern having a plurality of holes, wherein the coded aperture is adapted to provide a resolution of at most about 180 micron, a detector on which a raw image is projected through the coded aperture; and a decoder that receives the raw image from the detector and produces an image having a resolution of at most about 180 micron In certain embodiments, imaging device is adapted to image photons emitted from a radioactive isotope of an element. In certain embodiments, the system resolution is at most 20 micron. In certain embodiments, the resolution of at most 20 micron is measured over a field of view of at least about 5 mm.

In certain embodiments, the system resolution is from 20 micron to about I micron.

In certain embodiments of the device, at least a part of the coded aperture is manufactured from at least one of tungsten, molybdenum, gold, copper, and manganese, a combination thereof and alloys thereof. In certain embodiments, at least a part of the coded aperture further comprises a supporting substrate.

In certain embodiments of the device, the coded aperture comprises a 604×604 No-Two-Holes-Touching (NTHT) MURA pattern with about 10 micron holes and a 1/32 open fraction. In certain embodiments of the device, the coded aperture comprises gold and an alloy of NiCo.

In certain embodiments, the device further comprises a rotating assembly associated with the coded aperture, wherein the rotation assembly is adapted to rotate the coded aperture by about a 90 degree angle such that at least a portion of near-field artifacts is eliminated from the image. In certain embodiments of the device, the rotating assembly is associated with a linear stage adapted to move in X, Y and Z directions.

In certain embodiments, the device further comprises an object holder adapted to hold a photon emitter, wherein the object holder is capable of movement in the X and Z direction to coordinate a focal plane with a detector plane to provide a first distance from the detector to the aperture of about 30 to about 40 mm and a second distance from the detector to the object of about 40 to about 60 mm.

In certain embodiments of the device, the object holder is further adapted to hold a biological specimen. In certain embodiments of the device, the biological specimen is a cell, tissue, organism or multi-cellular organism.

### BRIEF DESCRIPTION OF SEVERAL VIEWS OF THE DRAWINGS

The invention will be described in conjunction with the following drawings in which like reference numerals designate like elements and wherein:

FIG. 1 is a scheme depicting a concept of coded aperture camera adapted from E. E. Fenimore and T. M. Cannon, supra.

FIG. 2A is a basic mask pattern used for an aperture (62×62 MURA NTHT). White represents the coefficient 1, black −1 and gray 0. FIG. 2B is decoding array associated with the mask.

FIG. 3A is a graph demonstrating the ratio of the SNR of the two NTHT MURA patterns to that of a single pinhole as a function oft. Square SNR is shown because it is proportional to time, activity, and number of holes for ψ=1, for which the ratio is the same as the ratio of the open fractions.

FIG. 3B is a graph demonstrating the sensitivity of the 604×604 pattern normalized to a single pinhole for increasing aperture-object distance. The ratio tends to the number of pinholes in the aperture (I 1402).

FIG. 4 is a simplified front view of the preferred embodiment of the device of the invention.

FIG. 5 is a simplified isometric view of a top plate.

FIG. 6 is a front elevation view of a top plate post.

FIG. 7A is a simplified isometric view of an object holder base.

FIG. 7B is a simplified isometric view of an object holder top surface.

FIG. 7C is a simplified isometric view of an object holder support.

FIG. 8 is a simplified isometric view of a rotating mounting plate.

FIG. 9 is a simplified top view of an assembly comprising a lens holder, the rotating mounting plate and the object holder top surface.

FIG. 10 is a simplified top view of the aperture.

FIG. 11A is an image reconstructed in a simulation using NTHT MURA 604×604.

FIG. 11B is an image reconstructed in a simulation using NTHT MURA 604×604.

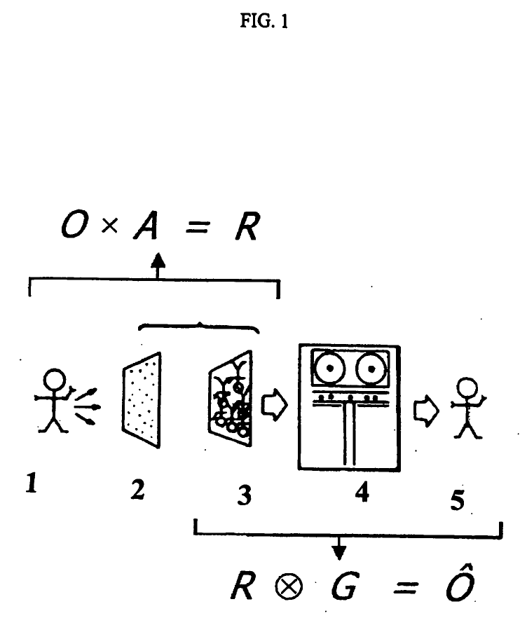

### DETAILED DESCRIPTION OF THE INVENTION

The invention was driven by the desire to develop a device capable of imaging objects on a scale of 280 microns or less. In the present invention, the synergy is achieved by the combination of low-energy photons (to obtain reduced penetration and high detection efficiency), a CCD detector (to obtain high-resolution), and coded aperture optics (to obtain high sensitivity and SNR). The low penetration of 3-10 keV photons in heavy materials opens the opportunity of designing high-resolution optics. The small solid angles involved cause low sensitivity but counts can be recovered with a desired coded aperture. A tool capable of imaging directly not large molecules, but single atoms, in a relatively short time, is appealing because of its potential for translating molecular imaging techniques to the space scale of a human somatic cell, thus making a powerful modality available to investigators in basic life science research.

The present invention can be used to study objects on a cellular scale to investigate, for example, the role of isolated ions as well as small and large molecules without altering their physicochemical properties. For its unprecedented resolution, the device has beyond state-of-the-art performance and opens an entirely new realm of potential applications. While it is difficult to predict the specific applications of the invention, it is reasonable to expect in vitro and in vivo applications to fundamental cell biology questions such as diffusion mechanisms and cell trafficking. The device of the invention, a soft-X-ray microscope, will make it possible to follow the evolution over time of the spatial distribution of biologically relevant isotopes, preferably elements from P to Ge, and more preferably K, Ca, Cr, Mn, Fe, Cu, Zn and I, with a resolution on the spatial scale of human cells. Low-energy photons do not penetrate the relatively heavy materials ofthe optics and the detector, but are also absorbed in the sample. A typical value is 50% attenuation of 5.89 keV (55 Fe) photons in 266 μm H₂O.

Advantageously, this invention utilizes low penetration in photon detection. Low energy photons can be stopped with good efficiency within thin materials. This helps high resolution imaging for two reasons. First, because pinholes have a smaller effective diameter; and, second, because low energy photons deposit their energy in a very localized fashion and can be detected with excellent intrinsic resolution. Photons in the 3-10 keV range can be stopped in less than 100 μm of silicon with efficiencies from 30 to 75%. In commercial X-ray CCD cameras, typical pixels have a width of a few tens of microns or less and the intrinsic resolution is essentially equal to the pixel size. For this reason, a large magnification is not needed to achieve resolutions ofthe order of the pixel size, and the FoV of the instrument is essentially the active area of the detector, which is about 2-3 centimeters. A custom-made Anger camera typically has a 10-cm crystal. Even assuming an intrinsic resolution of 1 mm, to achieve 10-μm resolution magnification would need to be about 100, which would reduce the FoV to 1 mm. Other favorable characteristics of CCD cameras include negligible readout noise with little contribution from dark current when the camera is cooled with liquid nitrogen, a standard and commercially available option. CCD technology also offers the advantages of an available, practical and relatively inexpensive technology.

The invention provides a method of imaging a spatial distribution of photon emitters, the method includes producing an image with a resolution of at most about 180 microns using an imaging device comprising a detector and a coded aperture, wherein a photon emitted from the photon emitter has an energy of at most about 35 keV (5.6×10⁻¹⁵ J). In certain embodiments, the energy of the photon is about 1 keV (1.6×10⁻¹⁶ J) to about 10 keV (1.6×10⁻⁵ J). In certain embodiments, the photon emitter has energy of at least 3 keV (4.8×10⁻¹⁶ J). Further provided is an imaging device for imaging a distribution of photons having energies of at most about 35 keV (5.6×10⁻¹⁵ J), the imaging device comprising a coded aperture comprising a mask pattern having a plurality of holes, wherein the coded aperture is adapted to provide a resolution of at most about 180 micron, a detector on which a raw image is projected through the coded aperture; and a decoder that receives the raw image from the detector and produces an image having a resolution of at most about 180 micron Further, imaging device comprises an object positioning system and a mask rotation system.

The invention will now be described in more detail below.

Detector Design

In certain embodiments, the detector is selected from the group consisting of pixelated (Nal, YAP:Ce, CsI) crystals coupled to a position sensitive photomultiplier tube (PSPMT), pixelated YAP:Ce on PSPMT, pixelated CsI on PSPMT, continuous Nal crystal directly coupled to PSPMT, Cs(I) coupled to a silicon drift detectors (SDD), CdZnTe arrays, 0.6mm for ⁵⁷Co, and a charge-coupled device chip. In certain embodiments, the detector is the charge-coupled device (CCD) chip. In the preferred embodiment, the detector is a Charged Coupled Device (CCD) chip, which is selected because of its high efficiency and resolution for photons in the range of interest, i.e. 3-10 keV. The CCD cameras can be of a deep-deletion or a non-deep-depletion type and also further distinguished as front- or back-illuminated. Depending on the specific type of detector, and especially on whether the detector is of deep-deletion type and if it is front- or back-illuminated, desired efficiency based on % of photons detected can be selected for the photons of interest. Non-deep-depleted devices have an efficiency lower by a factor of 2 or 3 as compared to the deep-depleted devices, as the depleted region is not as extended as in deep-depleted devices. These detectors may still be a practical solution because, due to their lower cost, several units can be utilized to recoup the sensitivity loss.

In the detector, different chips offer different pixel sizes in a range, for example, from about 10 to about 25 μm. Resolution is very close to these values, even though part of the charge may be shared by first neighbors, thus spreading the event over different pixels (“split” events). In certain embodiments of the invention, this decrease in resolution is accepted; in other embodiments, “split” events are rejected by using spectroscopy techniques since the expected count rate is very low and that chips can be read out very quickly.

In the preferred embodiment, the CCD camera sensible to X-rays is the commercially available PI-LCX:1300/LN (Princeton Instruments, Trenton, N.J.) which is a silicon deep-depletion, front-illuminated 1300×1340 array of 20×20 μm² pixels. Efficiency is appreciable in the 2-20 keV range, above 30% from 3 to 10 keV, and peaks at 75% between 5 and 6 keV. The Be window used to maintain vacuum with minimal attenuation for detector cooling purposes has the added benefit of blocking <2 keV photons. The CCD is a 1340×1300 array of 20×20 μm pixels.

In high-resolution applications in which small activity distributions are studied, very low count rates are expected at the detector. An overestimate of the expected activity in the sample is 100 μCi (3.7 MBq). Assuming a distance of 5 cm from the detector, the count rate expected is 1.177 10⁴ cps/cm². Assuming 10×10 μm²=10⁻⁶ cm² pixels the expected count rate in each pixel is 1.177 10⁻² s⁻¹, which is about 0.7 counts per minute. A more typical count rate is at least a factor of 10 less than this, i.e. about 0.35 counts per pixel every 5 minutes, which we regard as an upper limit for an acceptable exposure time.

CCD Spectroscopy

Assuming 70% detection efficiency, this means that there is a

$${\sum }_{x \geq 2} {ⅇ}^{- 0.35 * 0.7} \frac{{( 0.35 * 0.7 )}^{x}}{x !} =$$

0.025 probability that 2 or more photons will be detected at the same x>2 x2 pixel. For this reason, when the charge accumulated in each pixel's well is digitized it will reflect the energy of each event. Since all events have the same energy, the residual 2.5% multiple events can be discriminated on the basis of their energy such that events outside the full-energy peak can be excluded when necessary. It is particularly important to discriminate cosmic ray events, which deposit a large amount of energy. The cosmic ray flux is about 1/cm²/min. On a chip with 1340×1300 20×20 μm pixels, the expected count rate is about 35 events/5 min. These events can be easily identified and screened out using energy information.

Chip readout times can vary depending on the desired application, however they would have to be balanced to account for noise introduced at longer exposure times. If long exposure times are used, it will eventually become very unlikely that pixels will see single events. For example, after 1 hour, 75% of pixels will have 2 or more events. If spectroscopic information is necessary, for example to reject scattered events, the detector needs to be read out and the acquisition restarted. The drawback of this technique is that it imposes some deadtime. Typical readout frequencies are 50 kHz and 1 MHz. The first value results in a long read time but is affected by lower readout noise. For a 1340×1300 pixel detector, 1.742 million pixels need to be read, which takes about 35 s at 50 kHz vs. 1.7 s at 1 MHz. At 50 kHz the read noise is 13 e⁻ or less, whereas at 1 MHz it is 30 e⁻ or less. In the preferred embodiment, the signal is at least 3 keV/3.62 eV (energy per e⁻-hole pair in Si)=829 e⁻, resulting in a better than 4% electronic noise.

Spectroscopic information possible is expected to be helpful in the discrimination of scatter and spurious events such as cosmic rays. The latter are expected for exposure times as long as 5 min and may influence significantly the reconstruction ofthe multiplexed data because they typically deposit a large energy density.

Under these conditions, the single most important characteristic is indeed not read noise, but detector dark current. Assuming that X-rays form the most commonly available isotope in this energy range, ⁵⁵Fe (5.89 keV, t_{1/2}=2.73 y), every detected event will produce 5890 eV/3.62 eV≈1600 pairs. This is the signal, compared to which the number of electrons that accumulate in each well. Dark current accumulates e⁻-hole pairs at a rate depending on factors such as material and pixel volume; the order of magnitude is 100 e⁻/s in each pixel at 20° C. Over a 5 min acquisition time, 3 10⁴ e⁻ are collected, which is a level much larger than the signal. However, these pairs are generated thermally and the production rate can be decreased dramatically by reducing temperature. Below −50° C. the temperature dependence is the same for Advanced Inverted and Non-Inverted Mode Operation chips. It is:

$$Q = {Q}_{293} 122 {T}^{3} {ⅇ}^{- \frac{6400}{T}}$$

where Q₂₉₃ is the dark current at 293 K in the units in which Q needs to be calculated and T is the temperature in K. At −60° C. (213 K) Q=1.1 10⁻² e⁻/s or 3.3 e⁻ in 5 min; at −110° C. (163 K) Q=4.6 10⁻⁷ e⁻/s or 1.4 10⁻⁴ e⁻ in 5 min. When these figures are compared to the signal, it is apparent that dark current is a problem only at room temperature, but it can be solved by thermoelectrical cooling with air/water (213 K) or liquid nitrogen (163 K) heat sinks.

All commercially available systems offer solutions for cooling. The detector and cooling systems are encased in a vacuum to reduce heat exchange with the environment. A 10-μm beryllium window is used to separate the vacuum from the environment while providing minimal attenuation for incoming photons. The beryllium window is also helpful in modulating the efficiency curve by passing only photons with relatively high energy. Other materials can be used in place of beryllium such as, for example, MYLAR.

Further, each pixel can contain a limited number of e⁻ before it overflows spilling charge to neighbors in its column (blooming). Typical capacities depend on operation mode and may be as low as 3 10⁵ e⁻. In our case this is equivalent to about 190 events. Since only a few are expected, well depth is not likely to be a limitation and blooming a problem.

Consequently, in normal operation, fast readout (about 1 MHz) is likely to find application if spectroscopic data are needed, but it will not be necessary to reduce dark current buildup or avoid blooming. During the setup and alignment of the system, however, it will be convenient to be able to produce quickly a series of images.

Since dark current is extremely low, especially at 163 K, accurate temperature control is not necessary. However, keeping dark current at a known and repeatable low level will stabilize the correction for background events.

All CCD chips may have fabrication defects and are classified by grade. The lower the grade, the fewer defects are present, but even a grade 0 chip, in spite of its cost, is not free of defects. These include pixels that spontaneously appear bright in the image, pixels that appear dark and columns that also appear dark starting from a certain point and extending to the edge of the detector. For the CCD 36-40 (Princeton Instruments, Trenton, N.J.), a grade 0 chip has up to 65 white spot defects, 50 dark spots and no dark columns. For grade one, these numbers are, respectively, 105, 100 and 3. The implications of these defects in terms of image quality can be evaluated only in connection with the design of the coded aperture.

A Coded Aperture or a Mask Design

Due to the limitations of current fabrication technologies, the size of the coded aperture is related to its thickness. If small features are needed, the thickness ofthe mask is limited. The minimum thickness is determined by the transparency of the mask material to X-rays, which depends on the energy of the photons as well as on the material of the aperture. Different materials, two levels of attenuation (97% and 99%) and two energies (5.89 and 10 keV) were analyzed, and results are presented in Table 1 below.

TABLE 1

| | | | | Thickness | | Thickness | |
|---|---|---|---|---|---|---|---|
| | | | | at 5.89 keV | | at 10 keV | |
| | ρ | μ^{†} (cm²/g) | | (μm) | | (μm) | |
| Material | g/cm³ | 5.89 keV | 10 keV | 1% | 3% | 1% | 3% |
| Mo | 10.22 | 350 | 83.5 | 12.87 | 9.8 | 54 | 41.1 |
| Cu | 8.96 | 119 | 215 | 43.2 | 32.9 | 23.9 | 18.2 |
| W | 19.3 | 361 | 92.5 | 6.61 | 5.03 | 25.8 | 19.6 |
| Au | 19.32 | 438 | 113 | 5.44 | 4.14 | 21.1 | 16.1 |
| Ni₈₆Co₁₄ | 8.8 | 110 | 204 | 47.5 | 36.2 | 25.7 | 19.5 |

^{†}Attenuation coefficient without coherent scattering.

The materials chosen were tungsten and molybdenum (the most common options for photo-etching fabrication), gold (selected for its high density and attenuation coefficient), an alloy of NiCo and copper (which are used as substrate in electroforming). An excellent option to stop Fe X-rays (5.89 keV, the most commonly available isotope in this energy range) is to use the immediately preceding element in the table ofthe elements, which is Mn (notably, Mn is not available at the present time for the preferred fabrication technique (i.e., electroforming)). The preferred material is then gold, as it requires the thinnest thickness to stop a given fraction of X-rays. About 5 μm of material is sufficient. Also, this material will have to be supported by a substrate for mechanical stability. A non-limiting example of the substrate material is NiCo, which can provide stable substrates as thin as, for example, 5 μm, for a total thickness of about 10 μm.

The aspect ratio achieved by most techniques is usually about 1:1, so that it is possible to fabricate holes with a side of approximately 10 μm. This is more readily achieved by electroforming. Other techniques include but not limited to electrical discharge machining (EDM), photoetching, and laser drilling. Electroforming has a limitation on the minimum center-to-center spacing between holes, which can be estimated as a distance of 2×thickness+feature diameter +10 μm. In this case, the sum is 40 μm. This minimum distance (i.e., 40 μm) precludes the use of No-Two-Holes-Touching (NTHT) MURAs with an open fraction of ⅛ because the minimum center-to-center spacing between holes is twice the size of the holes. The NTHT MURA masks are described by Accorsi et al., supra.

The coefficient of attenuation at 5.89 keV for Au is 438 cm²/g (see Table 1). Only 5.4 μm of material are needed to obtain 99% attenuation, which can be plated on a substrate of 5 μm NiCo for mechanical stability by electroforming (Metrigraphics, Wilmington, Mass.). Since holes have a 1:1 aspect, the minimum hole size is 10 μm and the minimum hole-to-hole distance to 40 μm. Since the projection of a hole on the detector needs to be sampled with a minimum of 2 pixels, a square coded aperture can have at most 650 positions and the minimum magnification m, defined for coded apertures as the ratio of the size of the projection of a hole on the detector and its actual size pₘ, is 4. These parameters determine, respectively, the pattern size and most other dimensions of the optics.

The pattern choice is an important consideration in the design of the mask. The NTHT MURA family can be used to generate an array with the correct minimum spacing at the cost of accepting an open fraction of 1/32. An open fraction 4 times lower has a clear impact on sensitivity, which is reduced by a similar factor. The impact in terms of SNR depends on the concentration parameter ψ.

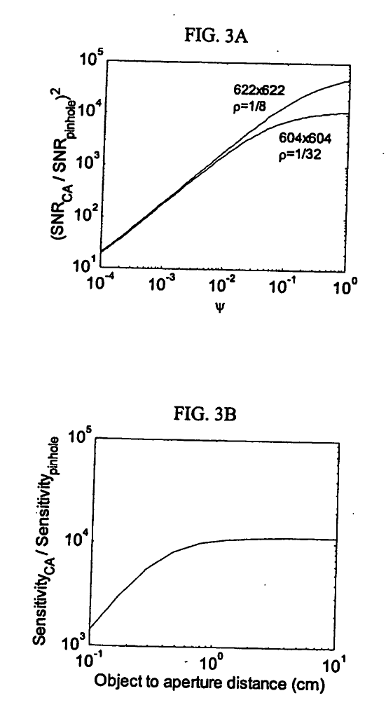

FIG. 3A shows the square of the SNR advantage of these two different designs over a pinhole with the same characteristics (i.e. hole size and field of view). The following formula was used:

$${SNR}_{CA}^{NTHT} = \sqrt{{N}_{T} {I}_{T}} \frac{\sqrt{ρ} ( 1 - t ) {ψ}_{i}}{\sqrt{( 1 - t ) [ ψ + 2 ρ ( 1 - ψ ) ] + 2 ( t + ξ )}}$$

which correctly predicts performance when ψ=1. The square of the SNR is proportional to activity and exposure time. Patterns of slightly different size were generated because the generation algorithm cannot always produce patterns ofthe same size for different values ofthe parameters, such as density. For ψ=1, i.e., for a dimensionless source, the less open design is inferior by about a factor of four, as can be deduced from the open fraction and a case of no superposition. This disadvantage decreases significantly with decreasing ψ. To calculate indicative values of ψ, the size of each reconstruction

In the preferred embodiment, the NTHT MURA pattern with 10 μm holes and a minimum distance of 40 μm was obtained by setting the parameter e to 4 (see Accorsi, et al., “Optimal coded aperture patterns for improved SNR in nuclear medicine imaging,” Nuclear Instruments and Methods in Physics Research A, 474, 3, 273-284, 2001), which sets ρ= 1/32. The largest anti-symmetric pattern with fewer than 650 positions was 604×604. With ρ=⅛ (the usual choice for e), the pattern would have been 622×622. 604×604 and patterns of the same or different array family leading to similar resolution and field of view when used in similar geometry.

The SNR of coded apertures depends on the distribution of activity in the object, which is described with the concentration parameter ψ. If Sᵢ is the number of counts due to source photons reconstructed at the i^{th} pixel of the image and passing through a single aperture hole, then ψᵢ=Sᵢ/ΣᵢSᵢ. The SNR of NTHT M URA patterns as a function of ψ and ρ has been defined in Accorsi et al., supra. FIG. 3A shows that the SNR depends significantly on ρ only for ψ>10⁻². In this geometry, a 250-μm-diameter disk of activity has ψ=3.4 10⁻³ at its points. Fabrication considerations, which influenced the choice of ρ, are not expected to impact SNR in practical cases, for which ψ<<1.

The projection of a mask pixel onto the detector needs to be sampled by at least two pixels if the maximum reconstructed intensity of a point source should not, as desirable, vary with its position. Since pixels are 20-μm wide magnification (in a coded aperture definition) needs to be at least 4.

The largest square imaging area ofthe LCX 1300 is 1300×1300 pixels, so that the largest pattern is 650×650. Since a spacing of 4 mask positions is needed between first neighbors, the MURA at the basis of the NTHT pattern is at most 162×162. The largest anti-symmetric pattern available is 151×151, resulting in an NTHT pattern 604×604. For this pattern the largest sampling parameter α is 1300/604=2.15, resulting in a maximum magnification of:

$$m = \frac{α {p}_{d}}{{p}_{m}} = 4.3$$

where p_{d} and pₘ are the pixel dimension in the detector and the mask, respectively. From the equations used in coded aperture imaging design the Field of View is

$$FoV = \frac{D}{m - 1}$$

where D is the side ofthe square imaging area used on the detector. With the 604×604 mask the FoV ranges from 8.2 to 8.6 mm. The pattern chosen has a side of 6.04 mm, whereas D=2.6 cm and FoV=7.87 mm. Maximum utilization of the detector requires, then, m=4.3. A reconstruction element in the image, therefore, is about 14 μm. The geometric resolution is:

$${λ}_{g} = {p}_{m} \frac{m}{m - 1}$$

which is about 13 μm. System resolution can be estimated by assuming that the intrinsic Full-Width-at-Half maximum of the detector (or the intrinsic resolution of the detector) is about 1 pixel, or 20 μm. The system resolution can be calculated as follows:

$${λ}_{s} = \sqrt{{{p}_{m}^{2} ( \frac{m}{m - 1} )}^{2} + {( \frac{{FWHM}_{i}}{m - 1} )}^{2}}$$

which is about 14.3 μm.

The dimension of the resolution element allows the calculation of the concentration parameter. For a source uniform over the cross section of a 250 μm-diameter bead (4908 μm²), ψ=3.4 10⁻³. This value is important because it shows that for commercially available point sources (IPL labs, Valencia, Calif.), ψ is such that the difference in terms of SNR for a ⅛ or a 1/32 open pattern is minimal.

From the geometric parameters calculated above it is now possible to estimate the sensitivity from a purely geometric calculation of solid angle. This is easy in the assumption of ideal mask, i.e. perfectly opaque and infinitely thin. Consequently for an object-to-pinhole (or coded aperture, which is the same) distance of about 1 cm, sensitivity is about 8 10⁻⁴ for the coded aperture and 8 10⁻⁸ for the pinhole. Accordingly, the equivalent number of pinholes is about 10⁴.

In a preferred embodiment, to obtain 1% attenuation, 5.4 μm Au are necessary. This amount can be plated on a 5-μm NiCo support for mechanical stability. Usually, coded apertures are fabricated with an open fraction ρ=½ or ρ=⅛, but this is incompatible with the limit set by fabrication considerations that the minimum size of the holes be 10 μm with 40 μm spacing. For this reason, a pattern with ρ= 1/32 was adopted (604×604 NTHT MURA). Despite a significant reduction in sensitivity with respect to more open arrays, the reduction in SNR is minimal for ψ<10-2. For reference, for a 250-μm disk W-3 10⁻³.

Sensitivity depends on the distance from the object. FIG. 3B shows the sensitivity ofthe coded aperture normalized to that of a pinhole having the same hole size and placed at the same distance from the object. For reference, at 1 cm, the sensitivity ofthe pinhole is 8 10⁻⁸. Above a few centimeters, the sensitivity increase equals the number of pinholes in the aperture (1402 for the pattern selected).

Correction of Near-Field and Misalignment Artifacts

In one embodiment of the invention, a mask rotation system is used to correct, reduce or eliminate the near-filed and misalignment artifacts. Near field artifacts arise when the coded aperture arrays developed for far-field applications are used in the near-field (see R. Accorsi and R. C. Lanza, “Near-field artifact reduction in coded aperture imaging,” Applied Optics, 40, 26, 4697-4705, 2001).

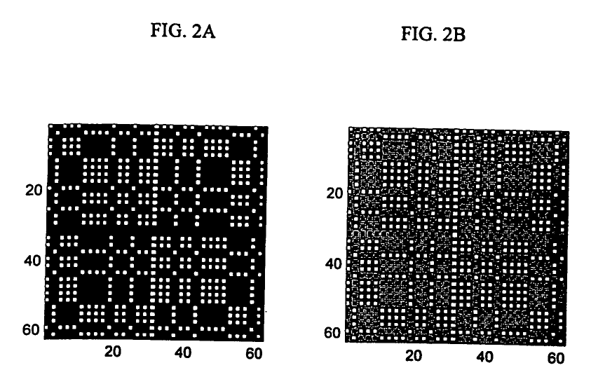

The artifacts appear when gamma rays originating from the same point in the FoV reach the detector with different incidence angle, a situation forced by the need to maintain a short distance from the object to maximize sensitivity. Under these conditions, the linearity of the equation (5) is violated and the procedure to undo the overlap does not produce an exact copy of the object. One remedy is based on the following: if the exposure time is divided in two halves and two images are taken, one with a mask and one with a mask with open and closed positions exchanged (the anti-mask) and the result added, artifacts, which affect both images, cancel in the sum. From a practical point of view, it is very advantageous to choose a mask with an axis or a center of odd symmetry, such as the mask of FIG. 2A. The anti-mask (FIG. 2B) can be obtained simply by rotation, and it is not necessary to fabricate two masks. In one embodiment of the device of the invention, such artifacts are corrected by a rotation of the aperture. In another embodiment two masks having decoding arrays which are negatives of each other can be used. Further, a plurality of detectors and a plurality of coded apertures at about a 90 degree angle relative to each other can be used to correct artifacts of moving and static objects.

As described in a published application US 20020075990A1 by Lanza et al., reducing and/or eliminating artifacts in near field imaging applications can be achieved by combining images obtained from passing a signal through (i) two masks having decoding arrays which are negatives of each other (a mask and a negative mask), wherein the masks are consecutively placed or (ii) one mask which is then rotated about its center by a certain angle (e.g., 90°). Further, a single detector detects signals passing through the first mask and then, the second mask wherein the second mask can be a separate mask from the first mask or it can be the same mask, which is rotated by 90°.

In certain embodiments of the device ofthe invention, near-field artifacts are corrected by using an anti-symmetric pattern so that an anti-mask is obtained by a 90° rotation of the mask (as described by Lanza et al., supra and R. Accorsi, supra). Acquiring a mask and an anti-mask image is helpful in reducing near-field artifacts and compensating detector non-uniformities.

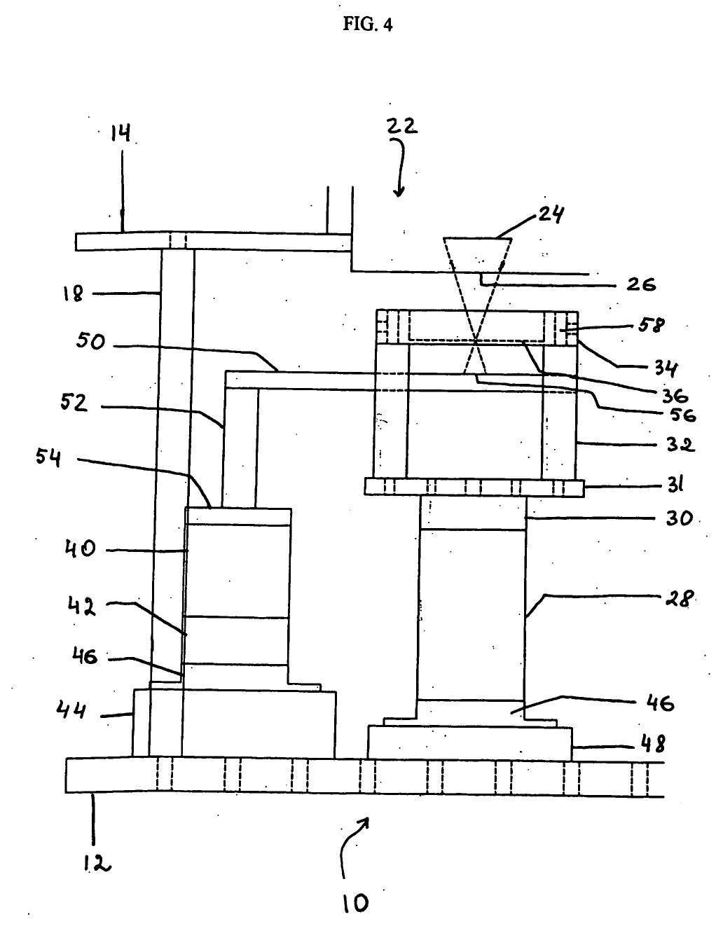

In certain embodiments, to avoid misalignment artifacts without relying on image manipulation, the position of the coded aperture would have to be adjusted to be within 15 μm (or other desired resolution of at most 280 micron (μm)) and 6 arc min. As shown in FIG. 4, the imaging device 10 comprises a coded aperture 36 and an object holder 50 (which is a part of a rotation assembly) are positioned with a rotation onto two 3D linear stages 40 and 42 designed for optical systems (Newport Corp, Irvine, Calif.). Similarly, the object can be translated in two directions with 10 μm sensitivity and along a third with 1 μm sensitivity, as may be needed to prove 14 μm resolution. An anti-symmetric mask pattern is used to correct for near-field artifacts (see, for example FIGS. 2A and 2B). The rotation mounting plate 31 and a precision rotating plate 31 provide the mechanism for the 90 degree rotation necessary for this correction. Even a grade 1 detector is affected by imperfections. Columnar defects and white spots are corrected in post-processing and will be then treated as dark defects. The number of these imperfections is such that their effect, which is in the order of a part in 500 or a part in 100 for longer exposures, is well below the expected count noise level. Thus, the mask alignment assembly comprises the object holder, a rotation stage and two 3 D linear stages.

In certain embodiments, eliminating near-field artifacts is done by utilizing two detectors and therefore increasing efficiency and eliminating the need to rotate the mask. Coded apertures could be mounted directly on the object holder because their rotation with respect to the object is no longer necessary. Correction of artifacts utilizing the plurality of detectors and the plurality of coded apertures at about a 90 degree angle relative to each other is described in detail by the inventor in a co-pending application entitled CODED APERTURE IMAGER WITH NEAR FIELD ARTIFACT CORRECTION FOR DYNAMIC STUDIES filed on even day with the present application.

Detector Mount and Object Positioning Equipment

The best way to demonstrate 10-μm resolution is to use two point sources at different distances, for example ever micrometer from 5 to 15 μm, and then verify that the image of the two point sources is distinct only for a spacing larger than 10 μm. Real point sources, however, have finite size and can be considered point-like only if their size is much smaller than the resolution of the instrument. In this case, this would be about 1 μm or less. The smallest sources obtainable, however, are, to our knowledge, in the range of at least a few tens of micrometers (see English et al., “Sub-Millimeter Technetium-99m Calibration Sources,” Molecular Imaging and Biology, vol. 4, no. 5, pp. 380-384, 2002). Thus, it is likely that resolution will be measured with some other method, e.g. as those based on following the known motion ofthe centroid of a given activity distribution. For the reasons mentioned above, such motion would need to be controlled with a precision of about 1 μm. Also, it is assumed that the rows and columns in the aperture will be parallel to those of the detector pixels. The precision to which these relative rotation angles should be measured can be obtained from the number of detector pixels. If the projection of each mask hole falls on two detector pixels, it is reasonable to expect that significant disruption of the reconstructed image will start to appear when the mask is rotated by an angle such that displacement at the edge ofthe detector is one pixel. Simulations confirm this estimate. Since the largest square field of view of the detector has 1300 pixels on its side, this angle is given by at an (1/650) <0.1=6 arc min. The rotation stage will need to position the coded aperture with this order of absolute precision or better.

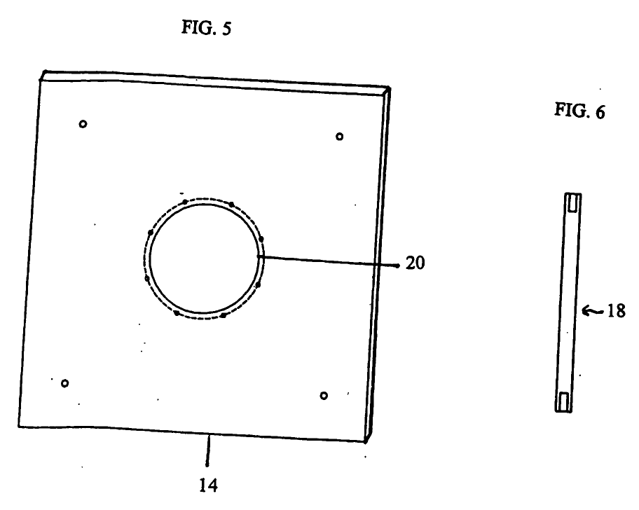

The preferred embodiment of the device of the invention is shown in FIGS. 4-10. The detector 22 (having a berillium window 26 and a detector plane 24) and cooling assembly (not shown) are mounted on an aluminum (or any other suitable material) frame 14, facing down. The coded aperture 36 and the object (a photon emitter) are positioned with commercial optical mounting modular components. Other modular components can be used. The distance from the detector to the aperture (38.1 mm) and the object (50.8 mm) can be adjusted by 5 mm. Modular components allowing the desired accuracy of positioning are commercially available from suppliers of optical equipment such as, for example, Newport Corp, Irvine, Calif. and ALIO Industries, Loveland, Colo. Two positioning columns are mounted on top of a breadboard 12. The first is centered on the breadboard and comprises a 3D compact linear stage 28 (DS40-XYZ) and a precision rotation stage 30 (RS40, absolute positioning within 6 arc min through Vernier absolute readout). On top of the latter are mounted two posts 32 (SP-2), which hold the lens holder 34 (LH-2). Inside this piece, the coded aperture 36 is mounted via a threaded ring 35. For further precision, a linear stages 46 (B2B) and a linear stages 48 (38)

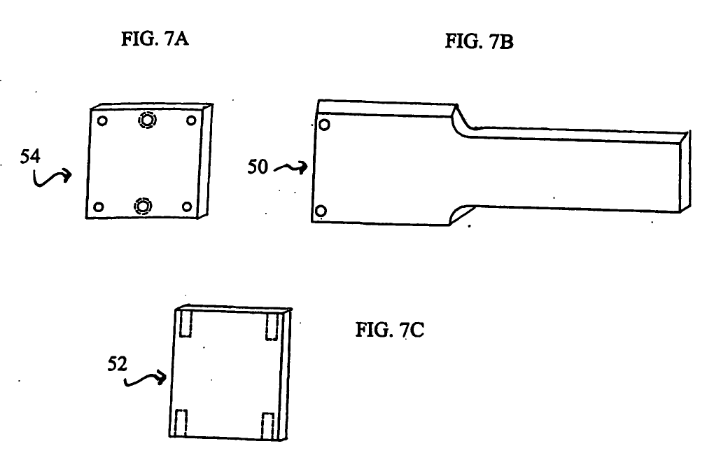

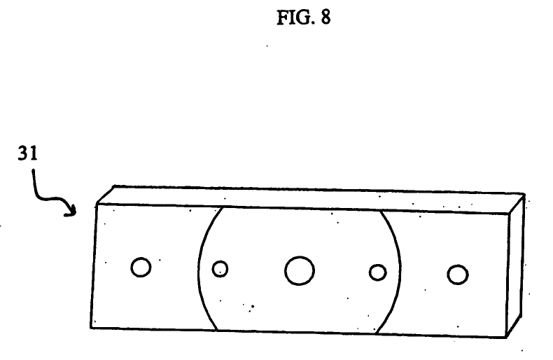

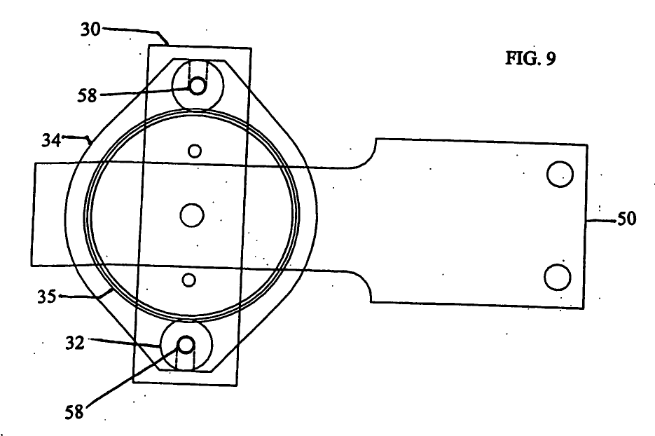

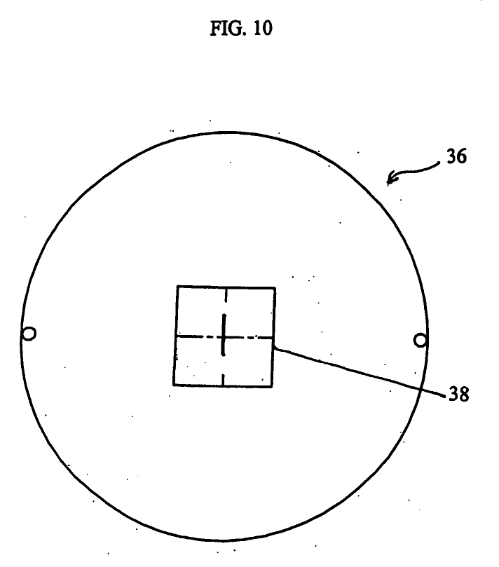

The second column is used to position and move the object. Two linear stages 40 and 42 (DS40-X and DS40-Z) are similar to those in the other column. X direction indicates movement in side to side direction in the plane of the FIG. 4, Y direction indicates movement in front and back direction (normal to the plane of the sheet, and Z direction indicates vertical movement in the plane of the sheet. However, along the Y direction, a different linear stage 44, with a precision of 1 μm, was used (423). On top of the Z stage, a custom-made springboard is mounted. The springboard is also shown in FIGS. 7A-C and can be made as a single unit or consist of several parts such as an object holder 50, an object holder support 52, and an object holder base 54. FIG. 8 shows a rotating mounting plate 31. FIG. 9 shows an assembly comprising a lens holder 34, two posts 32 (SP-2), a connecting opening 35 for mounting the aperture, the object holder 50, the rotating mounting plate, and the connecting studs 58. FIG. 10 shows the aperture 36 and a mask pattern 38.

Calibration Sources and Design

Ion exchange ⁵⁵Fe microbeads with a diameter of 250 μm and activity between 10 and 100 μCi are commercially available (IPL Labs, Valencia, Calif.) for calibration and performance evaluation. Custom sources with 40-100 μm diameter can be prepared conveniently in a nuclear medicine laboratory using guidance from English et al., supra.

As predicted by theory, simulation confirms that only the coded aperture can produce an image of this source. The simulation in which a single cell is injected to study how the tracer diffuses over time was conducted to study the activity distribution. In the simulation, a pinhole and a coded aperture (604×604 NTHT MURA pattern with 10 μm holes and 1/32 open fraction) were utilized with a 250-μm ⁵⁵Fe disk; activity was 370 kBq and the acquisition time was 300 s. Clearly, only the coded aperture produced an image in a cellular scale distinguishable from noise or artifacts.

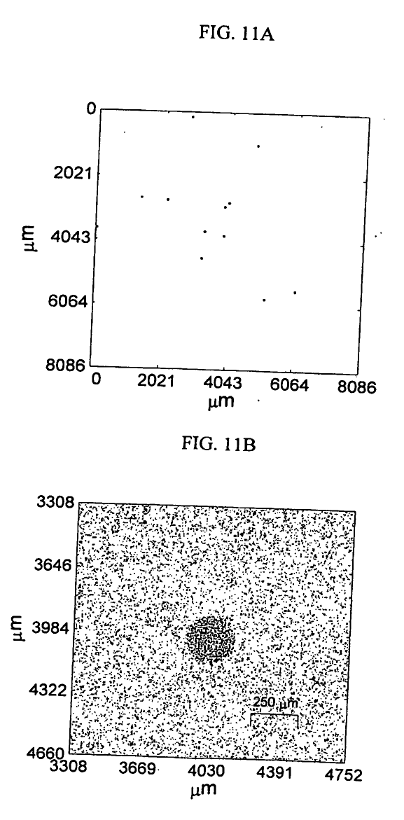

The performance of the device described above was simulated and the expected image was reconstructed after a 10-min exposure of a 10 μCi source having a diameter of 250 μm as shown in FIGS. 11A and B. FIGS. 11A and B demonstrate that the device ofthe invention should be capable of discriminating the source from the background.

As in all linear imaging systems, the single most informative performance check is the acquisition ofthe Point Spread Function (PSF). In theory, this operation requires the availability of a dimensionless point source, but in practice a source with dimensions much smaller than the resolution of the instruments are sufficient for a significant test, i.e., a source with dimensions in the order of 1 μm.

The preferred isotope is ⁵⁵Fe, because it decays by electron capture to a stable isotope, so that it does not emit any charged particles. Its only emissions are X-rays from the electronic shell of ⁵⁵Mn and are in the range 5.888 to 6.490 keV. The half life of ⁵⁵Fe is 2.73 years. Assuming a density of 7.88 g/cm³, a 1-μm-diameter sphere of pure ⁵⁵Fe has a weight of 4.12 pg, corresponding to 4.52 10¹⁰ atoms, for an activity of about 365 Bq (10 nCi). Thus, even if it were possible to fabricate such a sphere, its activity would be impractically low.

Activity is inversely proportional to half-life, and other isotopes can be used. Non-limiting examples of other isotopes include ⁵¹Cr, which also decays by electron capture to a stable isotope (half-life 271 days), but emits a 320 keV (yield 10%) γ ray along with X-rays (4.945-5.427 keV, yield 23%); and ⁵⁸Co (half-life 71 days), which may emit a positron (14% yield) along with a 810 keV photon and iron X-rays.

At these energies attenuation and stopping coefficients are such that shielding aiming at stopping relatively high-energy charged particles will also stop relatively low-energy photons, i.e. the signal. Charged particles can disturb the image. Therefore, an isotope emitting no charged particles such as ⁵⁵Fe is preferred. However to increase the count rate, other isotopes can be used also, wherein charged particles can be stopped with the help of a magnetic field and discriminated from photons events in the detector by energy discrimination.

While the invention has been described in detail and with reference to specific examples thereof, it will be apparent to one skilled in the art that various changes and modifications can be made therein without departing from the spirit and scope thereof.

What is claimed is:

1. A method of imaging a spatial distribution of photon emitters, the method comprising producing an image with a resolution of at most about 180 microns using an imaging device comprising a detector and a coded aperture, wherein a photon emitted from the photon emitter has an energy of at most about 35 keV (5.6×10⁻¹⁵ J).

2. The method of claim 1, wherein the energy of the photon is about 1 keV (1.6×10⁻⁶ J) to about 10 keV (1.6×10⁻¹⁵ J).

3. The method of claim 1, wherein the photon emitter has energy of at least 3 keV (4.8×10⁻¹⁶ J).

4. The method of claim 1, wherein the photon emitter is a radioactive isotope of an element.

5. The method of claim 4, wherein the element is a Periodic Table Element.

6. The method of claim 4, wherein the element is at least one of Periodic Table Elements 18 through 80.

7. The method of claim 5, wherein the element is at least one of Periodic Table Elements 18 through 32 and 47 through 80.

8. The method of claim 5, wherein the element is a member selected from the group consisting of Fe, K, Ca, Cr, Mn, Cu, Zn, Co, and I.

9. The method of claim 1, wherein the resolution of at least about 10 μm is measured over a field of view of at least about 8.2 mm.

10. The method of claim 1, wherein the detector is a member selected from the group consisting of pixelated (NaI, YAP:Ce, CsI) crystals coupled to a position sensitive photomultiplier tube (PSPMT), pixelated YAP:Ce on PSPMT, pixelated CsI on PSPMT, continuous Nal crystal directly coupled to PSPMT, Cs(I) coupled to a silicon drift detectors (SDD), CdZnTe arrays, 0.6 mm for ⁵⁷Co, and a charge-coupled device chip.

11. The method of claim 1, wherein the detector is the charge-coupled device (CCD) chip.

12. The method of claim 1, wherein the imaging device comprises a rotation assembly adapted to rotate the coded aperture by about a 90 degree angle such that at least a portion of near-field artifacts is eliminated from the image.

13. The method of claim 1, wherein a biological specimen is observed, either statically or dynamically.

14. An imaging device for imaging a distribution of photons having energies of at most about 35 keV (5.6×10⁻¹⁵ J), said imaging device comprising:
a coded aperture comprising a mask pattern having a plurality of holes, wherein the coded aperture is adapted to provide a resolution of at most about 180 micron;
a detector on which a raw image is projected through the coded aperture; and
a decoder that receives the raw image from the detector and produces an image having a resolution of at most about 180 micron

15. The imaging device of claim 14, wherein the imaging device is adapted to image photons emitted from a radioactive isotope of an element.

16. The imaging device of claim 14, wherein the system resolution is at most 20 micron.

17. The imaging device of claim 16, wherein the resolution of at most 20 micron is measured over a field of view of at least about 5 mm.

18. The imaging device of claim 14, wherein the system resolution is from 20 micron to about 1 micron.

19. The imaging device of claim 14, wherein the photons have energies from about 1 keV (1.6×10⁻¹⁶ J) to about 10 keV (1.6×10⁻¹⁵ J).

20. The imaging device of claim 14, wherein the photons have energies of at least 3 keV (4.8×10⁻¹⁶ J).

21. The imaging device of claim 14, wherein the detector is a member selected from the group consisting of pixelated (NaI, YAP:Ce, CsI) crystals coupled to a position sensitive photomultiplier tube (PSPMT), pixelated YAP:Ce on PSPMT, pixelated CsI on PSPMT, continuous NaI crystal directly coupled to PSPMT, Cs(I) coupled to a silicon drift detectors (SDD), CdZnTe arrays, 0.6 mm for ⁵⁷Co, and a charge-coupled device (CCD) chip.

22. The imaging device of claim 14, wherein the detector is the charge-coupled device (CCD) chip.

23. The imaging device of claim 14, wherein at least a part of the coded aperture is manufactured from at least one of tungsten, molybdenum, gold, copper, and manganese, a combination thereof and alloys thereof.

24. The imaging device of claim 14, wherein at least a part of the coded aperture further comprises a supporting substrate.

25. The imaging device of claim 14, wherein the coded aperture comprises a 604×604 No-Two-Holes-Touching (NTHT) MURA pattern with about 10 micron holes and a 1/32 open fraction.

26. The imaging device of claim 25, wherein the coded aperture comprises gold and an alloy of NiCo.

27. The imaging device of claim 14, further comprising a rotating assembly associated with the coded aperture, wherein the rotation assembly is adapted to rotate the coded aperture by about a 90 degree angle such that at least a portion of near-field artifacts is eliminated from the image.

28. The imaging device of claim 27, wherein the rotating assembly is associated with a linear stage adapted to move in X, Y and Z directions.

29. The imaging device of claim 14, comprising an object holder adapted to hold a photon emitter, wherein the object holder is capable of movement in the X and Z direction to coordinate a focal plane with a detector plane to provide a first distance from the detector to the aperture of about 30 to about 40 mm and a second distance from the detector to the object of about 40 to about 60 mm.

30. The imaging device of claim 14, wherein the object holder is further adapted to hold a biological specimen.

31. The imaging device of claim 14, wherein the biological specimen is a cell, tissue, organism or multi-cellular organism.
